(19) United States
(12) Patent Application Publication
(10) Pub. No.: US 2010/0221493 A1
(43) Pub. Date: Sep. 2, 2010

(54) USE OF SILANE-TREATED PARTICLES IN LAMINATES TO IMPROVE CLARITY

(76) Inventor: Mats Hintze, Angelholm (SE)

Correspondence Address: NOVAK, DRUCE + QUIGG L.L.P. - PERGO, 300 New Jersey Ave, NW, Fifth Floor, Washington, DC, 20001, US

(21) Appl. No.: 12/623,039

(22) Filed: Nov. 20, 2009

Related U.S. Application Data
(60) Provisional application No. 61/116,847, filed on Nov. 21, 2008.

(51) Int. Cl. E04C 2/24; B05D 5/02; B44F 9/00; B32B 5/16; B44C 1/00

(52) U.S. Cl. 428/145; 427/482

(57) ABSTRACT

The invention relates to a substrate having at least one décor layer or overlay being applied to at least one surface of the substrate, wherein hard particles are distributed over the décor layer or overlay for improving the abrasion resistance of the décor layer or overlay, wherein the hard particles have a coating containing a silane, preferably an aminosilane, providing a chargeable or electrically conductive surface for the coated particles. Furthermore, the invention relates to a process for the distribution of hard particles on a décor layer or overlay applicable to a substrate, comprising the steps of applying a thermosetting resin to the décor layer or overlay, providing hard particles having a coating containing a silane, preferably an aminosilane, providing a chargeable or electrically conductive surface for the coated particles, evenly distributing the coated particles on the surface of a feeding device, distributing the coated particles on the décor layer or overlay by releasing the evenly distributed particles from the feeding device by use of an electric field applied to the feeding device and coated particles thereon, and drying or curing the thermosetting resin.

### 1. FIELD OF THE INVENTION

The present invention relates to a substrate having at least one décor layer or overlay being applied to at least one surface of the substrate, wherein hard particles are distributed over the décor layer or overlay for improving the abrasion resistance of the décor layer or overlay. Furthermore, the invention relates to a process for the distribution of hard particles on a décor layer or overlay applicable to a substrate.

### 2. DESCRIPTION OF PRIOR ART

Products covered with a decorative thermosetting laminate are frequently used today. They are mostly used where the demands for abrasion resistance are high, but also where a resistance against different chemicals and humidity is required. Floor boards, floor skirtings, table tops and wall panels can be mentioned as exemplary embodiments of such products.

Decorative thermosetting laminates are often made of up to 7 Kraft paper sheets impregnated with phenolfolmaldehyde resin and a decor paper sheet impregnated with melamine-formaldehyde resin and a decor paper sheet impregnated with melamine-formaldehyde resin or another thermosetting resin. The decor paper sheet can be monochromatic or patterned with a wood or tile pattern or a fancy pattern (which can imitate other atypical flooring designs, such as a waterfall, or a non-natural design, such as a company logo), and placed at the top layer in the laminate.

Often one or more so-called overlay sheets of a-cellulose, usually impregnated with melamine-formaldehyde resin, are placed on top of the decor paper to protect the decor paper sheet from abrasion.

There are also laminates consisting of a base layer or core of particle board or fiber board provided with such a decor paper sheet and possibly an overlay sheet. These sheets can be laminated towards the base layer under heat and pressure where the resins themselves form the bond between the different structures. If a decor paper only is used and no overlay sheet, the decor paper sheet can be glued towards the base layer instead.

Suitable core materials include one or more of wood based material, such as wood, fibreboard such as high density fibreboard (HDF) or medium density fibreboard (MDF), veneers (of any thickness between 0.01 and 10 mm, typically between 0.5 and 2 mm), such as plywood, oriented strand board, cores made from particles (including discrete pieces of polymer or wood, which can be in the form of chips, curls, flakes, sawdust, shavings, slivers, stands, wafers, wood flour, wood wool and/or fibres), polymer (thermosetting and/or thermoplastic), flaxboard, stone (e.g., ceramic, marble, slate), cardboard, concrete, gypsum, high density fiber reinforced plaster, and other structural materials, such as metals (e.g., brass, aluminium, steel, copper, composites, composites or alloys). In some embodiments, the core material can be foamed (either open cell or closed cell), such as polyurethane. In still further embodiments, the core is made as a composite from multiple materials (such as those listed above), either as a heterogeneous mass, multiple layers or defined sections, e.g., upper and lower veneers covering a core of particles. Any of the above materials may also be provided with antistatic or antibacterial properties, e.g., by the inclusion of silver flakes, powders or particles, carbon black, ceramics, organic compounds or other metals or alloys. Preferred plastics include extrudable and/or moldable thermosetting and/or thermoplastic resins, the latter including high density olefins and polyvinylchloride.

In another embodiment, the core material itself has the décor, i.e., without the paper layer, e.g., as described by, e.g., U.S. Pat. No. 6,465,046. Those parts of U.S. Pat. No. 6,465,046 describing the core material with an integrated décor are incorporated herein by reference. In one embodiment, the core is optionally provided with a primer and/or a base colour, on which the decorative pattern or display is printed or otherwise generated. While the term “pattern” is used herein, it is to be understood that “pattern” need not be or include any repeating units, thus “pattern” is simply a visual and/or textual display. Once the décor is complete, the printed décor can be covered with a wear layer, thereby giving the décor abrasion and/or scratch resistance. The wear layer can be provided in the form of a sheet of alpha-cellulose which is bonded to the core, loose cellulosic fibers in a polymer vehicle, or it can be applied in a liquid form, and is typically provided with hard particles as described herein. The wear layer can include melamine-formaldehyde, urea-formaldehyde, maleamid, lacquers, acrylic resins, and/or urethanes; a thermoplastic material, especially ionomeric thermoplastics sold under the trademark SURLYN.

Often, the result of the printing process of the invention resembles a natural or synthetic object, such as wood or wood tiles or boards, ceramic (e.g., tiles), stone (including marble and granite, such as tiles), or fantasy patterns (i.e., those not found in nature), including a monochromatic or random field.

The resulting products typically have a durability rating. As defined by the European Producers of Laminate Flooring, such products can have an abrasion resistance rating of anywhere from AC1 to AC6. Typical abrasion resistances are >300 cycles, >400 cycles, >500 cycles, at least 900 cycles (AC1), at least 1500 cycles (AC2), at least 2000 cycles (AC3), at least 4000 cycles (AC4) at least 6000 cycles (AC5), and at least 8500 cycles (AC6) as measured by European Standard EN 13329:2006 (Annex E). The products can also have a Class-rating of 21, 22, 23, 31, 32, 33 or 34 (as defined by the EN13329:2006+A1:2008. Typical products according to the invention can also have impact resistance ratings of IC1, IC2, IC3, IC4, as measured by European Standard EN 13329:2006 (Annex F). The product can also exhibit a Resistance to Cigarette Burn, according to EN 438 of any value above 2, typically at least 4 or 5.

Moreover, the invention (or a subsequent device) can provide the printed image with a texture which enhances the pattern of the underlying printed image. Such texturing can be created to be “in register,” or in registration, with, offset from, or made to contrast with the image of the paper sheet. Such texturing may be created by physical pressing, e.g., embossing (as taught by U.S. application Ser. No. 10/440,317 (filed May 19, 2003), U.S. Pat. No. 7,003,364, and WO9731775 and WO9731776) or chemically created (as taught by U.S. Pat. No. 6,991,830)). The texture can be selected by the installer, designer or customer to enhance (e.g., match or contrast with) any texture of adjacent or included surfaces. The texture may also be provided on the decor such that features of the texture extend from a flooring element onto and possible completely across the adjacent flooring elements, which texture may, or may not coincide with the underlying décor.

The core material can be of any regular or irregular geometric shape, e.g., circular, curved, octagonal, hexagonal, triangular. When the substrate is rectangular (e.g., with one set of long sides and one set of short sides), the long sides are usually provided with joining elements permitting joining to another article by relative horizontal movement, relative rotational movement or relative vertical movement or a fold down movement, such as shown in the disclosure of WO 2006/043893 and U.S. Pat. Nos. 6,854,235 and 6,763,643 and U.S. Pat. Appl. Pub. No. 2007/0006543, especially the drawings thereof. Such relative horizontal movement can be a sliding motion along a side, joining only one entire side at once, or joining multiple sides at once, as shown in FIGS. 4-7 of U.S. Pat. No. 6,823,638. The short sides of such shapes can also be, but need not, assembleable by relative horizontal movement and may lock with our without snapping. The joints can include a slideable or deformable element, such as a metal or plastic spring or clip (as described by U.S. Pat. No. 6,647,690), or in an alternative, a static element to hold the panels together once assembled.

The laminates of the invention are typically used in the construction of a surface, such as a top for a counter or table, floor, ceiling, or wall. Such surfaces are often found in residential structures (e.g., single and multi-family houses, condominiums, townhomes, co-operatives, apartments, and lobbies of such buildings), commercial structures (e.g., retail stores, strip malls, shopping malls, office buildings, hotels, restaurants, supermarkets, banks, churches, airports and other transit stations), public structures (e.g., stadiums and arenas, schools, museums, theaters, post offices, hospitals, courthouses and other government buildings), as well as industrial structures (e.g., manufacturing plants, mills, and warehouses) and surfaces of vehicles (e.g., ships, trains, aircraft, public and private busses, cars and other motor vehicles).

To further increase the abrasion resistance of the decor paper sheet and/or the possible overlay sheet these may be provided with a hard particles which, most typically, are applied as a coating. These particles can be applied to the paper by mixing them into the thermosetting resin used for impregnating the paper. Finally, the resin impregnated paper is can be coated with hard particles by applying the hard particles onto the paper before drying the resin. Particles may also be incorporated into the paper itself, e.g., added to the pulp during the paper making process or can be dispersed in the resin used to impregnate or coat the paper.

Typical hard particles, as used herein, include alumina (a aluminium oxide), silicon carbide, cerium oxide, titanium oxide, diamond and synthetic materials, such as Zeeospheres (available from 3M). These particles exhibit a Moh's hardness of at least 2, typically at least 4, and preferably at least 6.

In order to achieve an even grade of abrasion resistance for the laminate, it is especially desired to ensure an even distribution of the hard particles within or atop the thermosetting resin. Furthermore, it is desired to provide for a clear and brilliant appearance of the surface even if the amount of hard particles within the top layer is quite high.

EP 0 837 771 discloses a process for the manufacturing of the decorative thermosetting laminate with an abrasion and scratch resistant surface layer in which a continuous paper web is impregnated with melamine-formaldehyde resin. One side of the web is evenly coated with hard particles of an average particle size of 5 to 500, typically 10 to 250, and preferably 30 to 90 μm, the other side of the web or a second paper web being coated with a melamine-formaldehyde resin containing hard particles with an average particle size of 0.001 to 100, typically 0.01 to 50 and preferably 1 to 15 μm. The distinct particle sizes provide for both an abrasion and scratch resistance of the decor layer.

Evenly distributing hard particles on the surface of a thermosetting resin can be achieved impregnated paper sheet or a thermosetting resin coated overlay by applying a so-called electrostatic strewing method in which the hard particles are fed onto a doctor-roll and subsequently discharged onto a continuously fed decor or overlay web. The discharge from the doctor-roll is performed by applying an electric field to the coated particles in order to release them from the doctor-roll. In order to achieve this effect, however, the hard particles usually have a conductive surface.

A process in which the electrical field applied to the hard particles present on the surface of such doctor-roll is for instance disclosed in EP 1 011 969 B1, the content of which relating to the apparatus performing the electrostatic strewing is incorporated herein by reference.

In order to be able to use the electrostatic strewing method disclosed therein it is necessary for the hard particles to be electrically conductive at least to a certain amount. This could be achieved by applying a conductive layer on top of the hard particle. In turn, such conductive layer could, however, detrimentally affect the appearance of these hard particles and thus the brilliance of the decor layer itself.

Due to the physical and chemical interactions between the particles and the resins used in typical laminates, the interface between the particles and the resin often causes the overlay to become cloudy. As a result, the cloudy overlay can obscure the image on the underlying décor.

In order to overcome the problems associated with cloudiness, the hard particles can be coated with a silane or silane compound. Silane is a chemical compound with the general chemical formula SiH₄. It is the silicone analogue of methane or more generally of an alkane hydrocarbon. Silanes consist of a chain of silicone atoms covalently bound to hydrogen atoms. The general formula of Silane is SiₙH₂ₙ₊₂, and the general formula may include one more substitutions, most typically for one or more of the hydrogen atoms. This silane can be used to enhance the brilliance of a surface layer having a large amount of hard particles distributed therein.

The problem with these silane coated hard particles is that the silane coating reduces the electrical properties of the particles, thus not allowing for applying the electrostatic strewing technique to be preferably applied in order to achieve an even distribution of the hard particles over the entire décor layer or overlay. Actually, using silane coated hard particles usually leads to an agglomeration of the hard particles even in a feeding device supplying the hard particles onto the decor layer or overlay. This, however, results in an uneven distribution of hard particles within the decor layer or overlay, thus remarkably reducing the abrasion resistance of the surface of a laminated structure.

### 3. OBJECT OF THE INVENTION

It was, thus, an object of the invention to provide a substrate having at least one décor layer or overlay being applied to at least one surface of the substrate, wherein hard particles can be evenly distributed over the décor layer or overlay for improving the abrasion resistance of the décor layer or overlay, preferably by applying the electrostatic strewing technique to at least a part of these hard particles.

It was, furthermore, an object of the invention to provide a process for the distribution of hard particles on a décor layer or overlay applicable to a substrate, by which the clarity of the décor of the laminate is not impaired and the abrasion resistance of the layer is at least as high as the abrasion resistance achievable by conducting the electrostatic strewing technique.

This object is achieved by a substrate having the features of claim 1, and by performing a process comprising the features of claim 15. Preferred embodiments of the invention are defined in the respective dependent claims.

### 4. SUMMARY OF THE INVENTION

According to the present invention, it is possible to provide a substrate having an abrasion resistance being at least as high as the abrasion resistance achievable by conducting the electrostatic strewing method when distributing the hard particles over the décor layer, and at the same time providing an enhanced clarity of the décor pattern on top of the substrate. The same results are obtainable by performing the process according to the invention.

In a first aspect of the invention, a substrate is provided, in which hard particles are distributed over the décor layer or overlay applied to at least one surface of the substrate. In order to improve the clarity of the décor, these hard particles are coated with a silane, preferably an aminosilane. Furthermore, and in order to avoid agglomeration during the distribution of these hard particles over the décor's or overlay's surface, or in order to be able to perform an electrostatic strewing method for this purpose, the coating provides for a chargeable or electrically conductive surface of the coated particles.

In order to be used in the electrostatic strewing method of the invention, the particles of the invention should have a resistivity at 15% relative humidity of less than 150 GO, preferably less than 15 GO and most preferably less than about 1 or even 0.5 GO and/or a resistivity at 50% relative humidity of less than 100 GO, preferably less than 1 GO and most preferably less than 0.1 or even 0.01 GO. Such resistivity can be measured according to BS5958, part 1. In this context, the skilled reader is aware of the fact that resistivity levels in the order of for instance 1 TO at 15% relative humidity or 0.5 TO at 50% relative humidity prevent an electrical conductivity of the coated particles when applying a potential which is suitable for applications in the field of hard particle distribution on décor layers such as paper sheets or overlays. The invention, thus, uses resistivity levels which ensure a sufficient electrical conductivity in the application in question.

The chargeable or electrically conductive surface of the coated particles can be achieved in any manner, for instance by a suitable selection of the silane used as the coating material. It is, however, preferred if the resistivity of the coating is adjusted by adding e modifying agent to the silane. The agent can be a separate coating at least partially surrounding the silane coating or simply be an agent added dispersed in the silane coating.

In an even more preferred embodiment of the invention, an organic agent acts in connection with the silane. The agent may be an aromatic amine, possibly as a layer on top of the silane coating or dispersed in the silane coating itself. In a more preferred embodiment, this aromatic amine is a biphenyldiamine derivate, most preferably a triarylamine which could act as a semi-conductor on top of the silane coating.

By using such a preferred chargeable or electrically conductive modifying agent as a coating on or with the silane coated hard particles, it is possible to achieve an improved abrasion resistance within the surface layer of a substrate by being able to perform the electrostatic strewing method, and furthermore, without reducing the clarity of the finished laminate by using an agent with the top layer of the coated hard particles which does not affect the effect provided by the silane coating remarkably.

An improved abrasion resistance may not only achievable by an even distribution of the hard particles over the surface of the decor layer or overlay, but also over the depth of the thermosetting resin layer to be applied to the decor layer or overlay before releasing the coated particle from a feeding device.

It is believed that the loading level of silane on the particle is a function of the surface area of the particle. For example, the silane coating can be 0.01 to 5.0%, typically 0.1 to 1.5% (weight percent silane on particle). The resistivity modifying agent may also be provided as a coating or layer on the silane layer. For example, the agent coating content can be 0.01 to 5.0%, typically 0.1 to 1.5% (weight percent agent on particle).

In a preferred embodiment of the invention, the thermosetting resin applied to the decor layer or overlay impregnates its substrate, especially when a paper sheet is used as decor layer. If an overlay is applied as a liquid to be dried or cured, such impregnation is achieved, if the thermosetting resin is at least partially mixed with this liquid.

The hard particles used according to the invention normally have an average particle size of around 1 to 100, preferably 50 μm, which is advantageous from an abrasion point of view. In a preferred embodiment of the process according to the invention, the average particle size of the hard particles is, therefore, in the range of 5 to 90, preferably 30 to 70 μm, most preferably of 40 to 60 μm. In a further preferred embodiment of the inventive process, the hard particles comprise aluminium oxide at least in an amount of at least 10 wt.-%, typically 50 wt.-%, preferably at least 90 wt.-%, such that a major fraction of the particles is aluminium oxide.

In this context, it is also known that providing hard particles with two different average sizes, the bigger ones improving the abrasion resistance, the smaller ones improving the scratch resistance, is desirable. A preferred particle size distribution within a coating to be applied to a decorative paper sheet or an overlay is for instance disclosed in EP 0 837 771 B1, whose parts relating to the particle size distribution are incorporated herein by reference as well.

According to the present invention, either or both of the size ranges may be provided with the silane-treatment as described herein. For example, the smaller size particles can be the “natural” particle (optionally dispersed in the resin) or silane-treated (with or without the resistivity modifying agent) and the larger particles may be silane-treated and delivered via the electrostatic method described herein.

In a preferred embodiment of the invention, only the bigger particles are coated with a silane providing the chargeability or conductivity used for the invention. Both particle ranges may then still be coated with a silane, one of which having a resistivity remarkably above 10 GO at 15% relative humidity, the other one having a resistivity within the preferred ranges given above.

In a further preferred embodiment of the substrate according to the invention, the decor layer or overlay to be applied to a substrate is a continuously feedable paper web, the thermosetting resin being a melamine-formaldehyde resin which is in particular suitable for impregnating a paper decor sheet. Furthermore, a melamine-formaldehyde resin provides for a clear and brilliant surface appearance in particular in combination with silane coated hard particles distributed therein.

In an alternative and equally preferred embodiment, however, the overlay is the outer surface of a direct printed product (which may or may not be digitally printed on the top surface), thus being applied in a substantially liquid manner on the top surface of the product in a printing process. After completion of the printing process, the overlay represents an evenly distributed top layer containing the hard particles. Preferably, these hard particles are coloured, advantageously with a colour which coincides with the colour of the decor pattern. This embodiment ensures that the pattern of the overlay fully coincides with the decor pattern applied to the printed product.

Preferably, the amount of the hard particles on top of the decor layer or overlay lies in the range of 0.05 to 50, typically 1 to 40 g/m², preferably at least 16, and up to 30 or 35 g/m². This provides for an advantageous balance of improved abrasion resistance of the decor layer or overlay without excessively affecting the brilliance and clarity of the decor layer or overlay itself.

In a second aspect of the invention, the process for the distribution of hard particles on a decor layer or overlay applicable to a substrate, which comprises the steps of applying a thermosetting resin to the decor layers or overlay, providing hard particles having a coating containing a silane and a resistivity modifying agent, which agent provides a chargeable or electrically conductive surface for the coated particles. An even distribution of the coated particles on the surface of a feeding device is achieved as described above, and the distribution of the coated particles on the decor layer or overlay is achievable by releasing the evenly distributed particles from the feeding device by use of electric field applied to the feeding device and the coated particles thereon. Finally, the thermosetting resin with the hard particles evenly distributed therein is dried or cured in order to achieve an abrasion resistant overlay or decor layer.

The present invention can use an apparatus for an even distribution of small hard particles to the surface of a decor layer or overlay, preferably a continuously fed paper web impregnated with a liquid thermosetting resin composition the resin being wet at the distribution of the hard particles.

Such an apparatus for performing an electrostatic strewing method preferably includes a feed hopper containing the hard particles. The hopper should have an outlet extending transversely of said fed paper web. A rotating doctor-roll preferably with an uneven surface is placed under the feed hopper and may be in communication with said outlet for reception of the hard particles therefrom. Furthermore, the doctor-roll should be spaced substantially parallel in relation to said paper web fed under the doctor-roll.

In a preferred embodiment of the claimed process, this apparatus also has a means for releasing the hard particles from the doctor-roll and distributing them evenly on the fed paper web. This means preferably comprises an electrode or electrode arrangement placed between the feed hopper and the downwards directed vertical tangent of the doctor-roll. The electrode arrangement or electrode is preferably enclosed by a casing provided with a downwards directed sliding plate, whereby the hard particles are lifted from the doctor-roll and fluidised by means of an electric field between the electro arrangement and the doctor-roll resulting in an even amount of particles falling down on the paper web fed under the doctor-roll.

In a highly preferred embodiment of the process according to the invention, the doctor-roll, the feed hopper and the paper of the decor layer or overlay have about the same voltage potential while the electrode or electrode arrangement has a positive or preferably a negative voltage potential of at least 1 kV as compared to the doctor-roll. The doctor-roll is preferably grounded and thereby uncharged. At least the surface of the doctor-roll is made of a conducting material, suitably a metal.

The skilled person of course knows that the suitable voltage potential depends on the distance between the electrode or electrode arrangement and the doctor-roll, the particulated materials and, to a certain extent, to the moisture of air surrounding the feeding device. By changing the distance and the voltage potential also the intensity of the field will be changed. However, intensities of a field which can result in an undesired electric discharge should be avoided.

Voltages amounting from 1 to 15 kV might be useful, but tests have shown that 2 to 8 kV is enough at a distance between the doctor-roll and the electrode or electrode arrangement of 5 to 20 mm, with aluminium oxide particles having an average size of between 40 to 90 μm.

Suitably, the aluminium oxide particles preferably used in the process according to the invention have the form of a-Al₂O₃ which is not hygroscopic. The distance between the doctor-roll and the electrode or electrode arrangement may be 2 to 15 mm, preferably 3 to 30 mm or 5 to 20 mm.

The electrode or electrode arrangement used in the process according to the invention preferably consists of one or more electrodes preferably made of a semiconducting material such as phenolic resin. The electrode or electrode arrangement is electrically connected to a voltage source via an electrically conductive distributor which suitably runs along the main part of the horizontal extension of the electrode or electrode arrangement.

Alternatively, the electrode or electrode arrangement can consist of a conductive material, but in this case said material is most often coated with an insulating material. The longitudinal side edges and all corners of the electrode or electrode arrangement should have a rounded surface, since otherwise the electric field will be concentrated there which might result in a formation of clusters of particles.

### 5. WAYS TO CARRY OUT THE INVENTION

In the following, the invention will be explained in more detail with reference to distinct examples embodying the process according to the invention. These examples, however, are not disclosed in order to limit the spirit and scope of the invention, which is defined in the appending claims only.

The abrasion tests performed in these examples was measured according to the standards as set out in EN 438-2:6. According to this standard, the abrasion through the decorative layer of the finished laminates is measured in two steps. In the first step the so-called IP (initial-point) is measured, where the initial abrasion starts. In the second step the so-called EP (end-point) is measured, where 95% of the décor is worn through. Additionally, the standard describes that the number of revolutions achieved with the testing machine in the first and second step are added, and that the obtained sum is divided by 2. Hereby the 50% point for abrasion is obtained, which normally is the figure reported in standards and offprints. In the following examples, however, only the IP is used.

### EXAMPLE 1

a) Aluminium oxide particles were produced by transforming bauxite or alumina in an electric arc furnace into a liquid state at temperatures of above 2,000° C. Subsequently, the fused aluminium oxide was cooled and crushed in a conventional manner. The sizing of the crushed aluminium oxide was performed by either sieving and/or sedimentation. After that, the silane coating was applied to the sized particles, and a modifying agent providing a chargeable or electrically conductive property to the silane coated particles was added, either by applying the agent to or on top of the silane coating.

b) One roll of so called overlay paper of a-cellulose with a surface weight of 25 g/m² was impregnated with a melamine-formaldehyde resin solution to a resin content of 57% by weight, calculated on dry impregnated paper. The top side of the wet paper web was sprinkled with aluminium oxide particles to an amount of 8 g/m². The particles had an average size of 50 μm. The particles were applied by using an apparatus as described in the U.S. Pat. No. 4,940,503.

The particle coated paper web was then continuously fed into a heating oven, where the solvent was evaporated while the resin cured to a so-called B-stage. The moisture content of the paper was after the drying 10% by weight. The other, not sprinkled side of the paper web was coated with a slurry of melamine-formaldehyde resin containing aluminium oxide particles to an amount of 5.3% by weight. The average size of the particles was 1 μm.

The paper web was then continuously dried in an oven until the moisture content of the paper was 7% by weight.

The final resin content of the completely impregnated paper was 70% by weight calculated as dry impregnated paper, and the total amount of added aluminium oxide particles was 8+2.7 g/m². The paper web was cut into sheets of a suitable length.

c) One roll of so called overlay paper of a-cellulose with a surface weight of 25 g/m² was impregnated with a melamine-formaldehyde resin solution to a resin content of 70% by weight, calculated on dry impregnated paper. The top side of the wet paper web was sprinkled with aluminium oxide particles to an amount of 7 g/m² by using the same apparatus as in b) above. The particles were of an average size of 50 μm. The paper web was then dried to a moisture content of 7% by weight. The paper web was cut into sheets of the same length as in b) above.

d) One roll of so called décor paper with a surface weight of 100 g/m² was impregnated with a solution of melamine-formaldehyde resin to a resin content of 46% by weight, calculated on dry impregnated paper. The impregnated paper web was dried to a moisture content of 4% by weight.

The paper web was cut into sheets of the same length as in b) and c) above.

e) One roll of Kraft paper with a surface weight of 170 g/m² was impregnated with a phenol-formaldehyde resin solution to a resin content of 28% by weight, calculated on dry impregnated paper. The wet paper web was dried to a final moisture content of 7% by weight. The paper web was cut into sheets of the same length as above.

The impregnated paper sheets as described in a)-e) above were placed between two press plates in the following order; one paper b) with the side with the smallest particles oriented outwards, one paper c) with the sprinkled side oriented outwards, one paper d) and three papers e). Together the last mentioned papers, so-called base sheets, formed a base layer in the laminate which was manufactured by pressing of the sheets in a conventional multi-opening press during 80 minutes and at a pressure of 85×10⁵ Pa (bar).

The properties of the manufactured laminate were as follows:

| | |
|---|---|
| Abrasion | 16100 revolutions |
| Scratch resistance | across/4 (distance), across/9 |
| | (real) |

### EXAMPLE 2

The procedure according to example 1 was repeated with the difference that the melamine-formaldehyde slurry in step b) contained aluminium oxide particles with an average size of 3 μm instead of 1 μm.

The properties of the manufactured laminate were as follows:

| | |
|---|---|
| Abrasion | 14050 revolutions |
| Scratch resistance | across/3 (distance), across/3 |
| | (real) |

### EXAMPLE 3

The procedure according to example 1 was repeated with the difference that the melamine-formaldehyde slurry in step b) contained 10.6% by weight of aluminium oxide particles instead of 5.3% by weight. Additionally the aluminium oxide particles had an average size of 5 μm instead of 1 μm. The total amount of particles was 8+5.4 g/m². The properties of the manufactured laminate were as follows:

| | |
|---|---|
| Abrasion | 15500 revolutions |
| Scratch resistance | cross/1 (distance) cross/7 (real) |

### EXAMPLE 4

The procedure according to example 3 was repeated with the difference that the melamine-formaldehyde slurry in step b) contained 15.9% by weight of aluminium oxide particles instead of 10.6% by weight. Also in this example the aluminium oxide particles had an average size of 5 μm. The total amount of particles added was 0+0.1 g/m². The properties of the manufactured laminate were as follows:

| | |
|---|---|
| Abrasion | 14200 revolutions |
| Scratch resistance | across/1 (distance), across/1 |
| | (real) |

### EXAMPLE 5

The procedure according to example 1 was repeated with the difference that the melamine-formaldehyde slurry in step b) contained aluminium oxide particles with an average size of 9 μm instead of 1 μm.

The properties of the manufactured laminate were as follows:

| | |
|---|---|
| Abrasion | 15100 revolutions |
| Scratch resistance | across/3 (distance), across/3 |
| | (real) |

### EXAMPLE 6

a) Aluminium oxide particles were produced by transforming bauxite or alumina in an electric arc furnace into a liquid state at temperatures of above 2,000° C. Subsequently, the fused aluminium oxide was cooled and crushed in a conventional manner. The sizing of the crushed aluminium oxide was performed by either sieving and/or sedimentation. After that, the silane coating was applied to the sized particles, and a modifying agent providing a chargeable or electrically conductive property to the silane coated particles was added, either by applying the agent to or on top of the silane coating.

b) One roll of so called overlay paper of a-cellulose with a surface weight of 25 g/m² was impregnated with a melamine-formaldehyde resin solution to a resin content of 57% by weight, calculated on dry impregnated paper. The top side of the wet paper web was sprinkled with aluminium oxide particles to an amount of 9 g/m². The particles were of an average size of 50 μm. The particles were applied by using an apparatus as described in the U.S. Pat. No. 4,940,503.

The particle sprinkled paper web was then continuously feed into a heating oven, where the solvent was evaporated while the resin cured to a so-called B-stage. The moisture content of the paper was after drying 10% by weight.

The other, not sprinkled side of the paper web was coated with a slurry of melamine-formaldehyde containing aluminium oxide particles to an amount of 10.6% by weight. The average size of the particles was 3 μm.

The paper web was then continuously dried in an oven until the moisture content of the paper was 7% by weight.

The final resin content in the completely impregnated paper was 72% by weight calculated as dry impregnated paper, and the total amount of added aluminium oxide particles was 9+5.4 g/m²

c) One roll of so-called overlay paper of a-cellulose with a surface weight of 25 g/m² was impregnated with a melamine-formaldehyde resin solution to a resin content of 72% by weight, calculated on dry impregnated paper. The paper web was then dried to a moisture content of 7% by weight.

d) One roll of so called décor paper with a surface weight of 100 g/m² was impregnated with a melamine-formaldehyde resin solution to a resin content of 46% by weight, calculated on dry impregnated paper. The impregnated paper web was dried to a moisture content of 4% by weight.

e) One roll of Kraft paper with a surface weight of 150 g/m² was impregnated with a phenol-formaldehyde resin solution to a resin content of 36% by weight, calculated on dry impregnated paper. The wet paper web was dried to a moisture content of 7% by weight.

The impregnated paper webs as described in a)-e) above were continuously feed in between the two press bands of a continuous press in the following order; one paper b) with the side with the smallest particles oriented outwards, one paper c), one paper d) and three papers e).

The pressing cycle lasted for 20 seconds and the pressure was 35×10⁵ Pa (bar) laminate was then cut into suitable lengths.

The properties of the manufactured laminate were as follows:

| | |
|---|---|
| Abrasion | 13900 revolutions |
| Scratch resistance | across/3 (distance), across/5 |
| | (real) |

### EXAMPLE 7

The procedure according to example 6 was repeated with the difference that the slurry of melamine-formaldehyde resin in step b) contained aluminium oxide particles to an amount of 5.3% by weight instead of 10.6% by weight. The average size of the particles was 1 μm instead of 3 μm. The total amount of added aluminium oxide particles was 9+2.7 g/m².

The properties of the manufactured laminate were as follows:

| | |
|---|---|
| Abrasion | 13900 revolutions |
| Scratch resistance | across/5 (distance), across/7 |
| | (real) |

### EXAMPLE 8

a) Aluminium oxide particles were produced by transforming bauxite or alumina in an electric arc furnace into a liquid state at temperatures of above 2,000° C. Subsequently, the fused aluminium oxide was cooled and crushed in a conventional manner. The sizing of the crushed aluminium oxide was performed by either scenting and/or sedimentation. After that the silane coating was applied to the sized particles, and a modifying agent providing a chargeable or electrically conductive property to the silane coated particles was added, either by applying the agent to or on top of the silane coating.

b) One roll of so-called overlay paper of a -cellulose with a surface weight of 25 g/m² was impregnated with a melamine formaldehyde resin solution to a resin content of 70% by weight, calculated on dry impregnated paper. The top side of the wet paper web was sprinkled with aluminium oxide particles to an amount of 8 g/m². The particles were of an average size of 50 μm. The paper web was then continuously dried in a heating oven to a moisture content of 7% by weight. The other side of the paper was left untreated and was therefore not coated with any hard particles. The paper web was cut into sheets of a suitable length.

Step c), d) and e) were repeated according to example 1.

The impregnated paper sheets according to a)-e) above were placed between two press plates in the following order; one paper b) with the particle side oriented downwards, one paper c) with the sprinkled side oriented outwards, one paper d) and three papers e). The pressing was conducted in the same way as in example 1. The properties of the manufactured laminate were as follows:

| | |
|---|---|
| Abrasion | 13550 revolutions |
| Scratch resistance | across/31 (distance), across/41 |
| | (real) |

### EXAMPLE 9

a) Aluminium oxide particles were produced by transforming bauxite or alumina in an electric arc furnace into a liquid state at temperatures of above 2,000° C. Subsequently, the fused aluminium oxide was cooled and crushed in a conventional manner. The sizing of the crushed aluminium oxide was performed by either scenting and/or sedimentation. After that the silane coating was applied to the sized particles, and a modifying agent providing a chargeable or electrically conductive property to the silane coated particles was added, either by applying the agent to or on top of the silane coating.

b) One roll of so-called overlay paper of a-cellulose with a surface weight of 25 g/m² was impregnated with a melamine-formaldehyde resin solution to a resin content of 50% by weight, calculated on dry impregnated paper. The paper web was then dried to a moisture content of 7.2% by weight.

One side of the paper was coated with a slurry of a solution of melamine-formaldehyde resin containing aluminium oxide particles to an amount of 5.0% by weight. The average size of the particles was 3 μm.

The paper web was then continuously dried in an oven until the moisture content in the paper was 8.6% by weight.

The final resin content of the completely impregnated paper was 70% by weight calculated on dry impregnated paper, and the total amount of added aluminium oxide particles was 3.3 g/m².

The paper web was cut into sheets of a suitable length.

c) One roll of patterned décor paper of a-cellulose with a surface weight of 38 g/m² was impregnated with a melamine-formaldehyde resin solution to a resin content of 50% by weight, calculated on dry impregnated paper. The top side of the wet paper web was sprinkled with aluminium oxide particles to an amount of 9.5 g/m² by using the same apparatus as in b) above. The particles were of an average size of 50 μm. The paper web was then dried to a moisture content of 6.7% by weight. The paper web was cut into sheets of the same length as in b) above.

d) One roll of monochromatic decor paper with a surface weight of 100 g/m² was impregnated with a melamine-formaldehyde resin solution to a resin content of 54% by weight, calculated on dry impregnated paper. The impregnated paper web was dried to a moisture content of 6.5% by weight.

The paper web was cut into sheets of the same length as in b) and d) above.

e) One roll of Kraft paper with a surface weight of 170 g/m² was impregnated with a phenol-formaldehyde resin solution to a resin content of 28% by weight, calculated on dry impregnated paper. The wet paper web was dried to a final moisture content of 7% by weight. The paper web was cut into sheets of the same length as above.

The impregnated paper sheets as described in a)-e) above were placed between two press plates in the following order; one paper b) with the particle coated side oriented outwards, three paper c) with the sprinkled side oriented outwards, one paper d) and three papers c). Together the last mentioned papers, so called base sheets, formed a base layer of the laminate which was manufactured by pressing the sheets in a conventional multi-opening press during 80 minutes and at a pressure of 85×10⁵ Pa (bar).

The properties of the manufactured laminate were as follows:

| | |
|---|---|
| Abrasion | 26100 revolutions |
| Scratch resistance | across/1 (distance), across/9 |
| | (real) |

### EXAMPLE 10

a) Aluminium oxide particles were produced by transforming bauxite or alumina in an electric arc furnace into a liquid state at temperatures of above 2,000° C. Subsequently, the fused aluminium oxide was cooled and crushed in a conventional manner. The sizing of the crushed aluminium oxide was performed by either scenting and/or sedimentation. After that the silane coating was applied to the sized particles, and a modifying agent providing a chargeable or electrically conductive property to the silane coated particles was added, either by applying the agent to or on top of the silane coating.

b) One roll of patterned decor paper of a-cellulose with a surface weight of 41 g/m² was impregnated with a melamine-formaldehyde resin solution to a resin content of 41% by weight, calculated on dry impregnated paper. The paper web was then dried to a moisture content of 6.7% by weight. One side of the paper web was then coated with a slurry of melamine-formaldehyde resin containing aluminium oxide particles to an amount of 5% by weight. The particles had an average size of 3 μm.

The paper web was then continuously dried in an oven until the moisture content of the paper was 7.4% by weight.

The final resin content of the completely impregnated paper was 63% by weight calculated on dry impregnated paper, and the total amount of added aluminium oxide particles was 3.3 g/m².

The paper web was cut into sheets of a suitable length.

c) One roll of patterned decor paper of a-cellulose with a surface weight of 41 g/m² was impregnated with a melamine-formaldehyde resin solution to a resin content of 49% by weight, calculated on dry impregnated paper. The top side of the wet paper web was sprinkled with aluminium oxide particles to an amount of 9.5 g/m². The particles were of an average size of 50 μm. The paper web was then dried to a moisture content of 7% by weight. The paper web was cut into sheets of the same length as in a) above.

The steps d) and e) according to example 9 were repeated and a laminate was manufacture in the same way as in example 9.

The impregnated paper sheets as described in a)-e) above were placed in the following order, one paper b) with the particle coated side oriented outwards, three papers c) with the sprinkled side oriented outwards, one paper d) and three papers e).

The properties of the manufactured laminate were as follows:

| | |
|---|---|
| Abrasion | 27100 revolutions |
| Scratch resistance | across/5 (distance), across/9 |
| | (real) |

1. A substrate having at least one décor layer or overlay being applied to at least one surface of the substrate, wherein hard particles are distributed over the décor layer or overlay for improving the abrasion resistance of the décor layer or overlay,
characterised in that
the hard particles have a coating containing a silane, preferably an aminosilane, providing a chargeable or electrically conductive surface for the coated particles.

2. A substrate according to claim 1, characterised in that the silane coating provides for a resistivity of less than 150 GO, preferably of less than 15 GO, more preferably of less than 1 GO and most preferably of less than 0.5 GO, at 15% relative humidity, and/or less than 100 GO, preferably of less than 1 GO, more preferably of less than 0.1 GO and most preferably of less than 0.01 GO, at 50 relative humidity.

3. A substrate according to claim 2, characterised in that the resistivity is adjusted by adding a modifying agent to or into the silane coating.

4. A substrate according to claim 3, characterised in that the modifying agent is an aromatic amine present on top of and/or in the silane coating.

5. A substrate according to claim 4, characterised in that the aromatic amine is a biphenyl diamine derivate, preferably triarylamine, acting as a semiconductor in or on top of the silane coating.

6. A substrate according to anyone of claims 2 to 4, characterised that the modifying agent is present as a separate layer on the outer surface of the silane coating.

7. A substrate according to one of the preceding claims, characterised in that the hard particles mainly contain aluminium oxide.

8. A substrate according to one of the preceding claims, characterised in that the hard particles have an average particle size of 1 to 100 μm, preferably 5 to 90 μm, more preferably 30 to 70 μm, and most preferably of 40 to 60 μm.

9. A substrate according to anyone of claims 1 to 7, characterised in that the décor layer or overlay contains hard particles having two different average particle sizes, the bigger average diameter being in the range of between 30 to 90 μm, the smaller average diameter being in the range of between 0.001 to 15 μm.

10. A substrate according to claim 9, characterised in that only the bigger particles are coated with the modifying agent.

11. A substrate according to one of the preceding claims, characterised in that the décor layer or overlay is a paper web, and that the thermosetting resin is a melamine-formaldehyde resin.

12. A substrate according to one of the preceding claims, characterised in that the amount of hard particles in or on top of the décor layer or overlay is in the range of 0.05 to 50 g/m², preferably of 1 to 40 g/m², most preferably of at least 16 and up to 35 g/m².

13. A substrate according to one of the preceding claims, characterised in that the the décor layer or overlay is a continuously fed web.

14. A substrate according to one of the preceding claims, characterised in that the décor layer or overlay provides for an abrasion resistant surface of a laminate, preferably being a part of a floor board, floor skirting, table top, or wall panel.

15. A process for the distribution of hard particles on a décor layer or overlay applicable to a substrate, comprising the steps of:
applying a thermosetting resin to the décor layer or overlay,
providing hard particles having a coating containing a silane, preferably an aminosilane, providing a chargeable or electrically conductive surface for the coated particles,
evenly distributing the coated particles on the surface of a feeding device,
distributing the coated particles on the décor layer or overlay by releasing the evenly distributed particles from the feeding device by use of an electric field applied to the feeding device and coated particles thereon, and
drying or curing the thermosetting resin.

16. A process according to claim 15, characterised in that the silane coating provides for a resistivity of less than 150 GO, preferably of less than 15 GO, more preferably of less than 1 GO and most preferably of less than 0.5 GO, at 15% relative humidity, and/or less than 100 GO, preferably of less than 1 GO, more preferably of less than 0.1 GO and most preferably of less than 0.01 GO, at 50% relative humidity.

17. A process according to claim 16, characterised in that the resistivity is adjusted by adding a modifying agent to or into the silane coating.

18. A process according to claim 17, characterised in that the modifying agent is an aromatic amine applied on top of and/or in the silane coating.

19. A process according to claim 18, characterised in that the aromatic amine is a biphenyl diamine derivate, preferably triarylamine, acting as a semiconductor in or on top of the silane coating.

20. A process according to anyone of claims 17 to 19, characterised that the modifying agent is applied as a separate layer to the outer surface of the silane coating.

21. A process according to anyone of claims 15 to 20, characterised in that the hard particles are evenly distributed over the surface and depth of the thermosetting resin.

22. A process according to anyone of claims 15 to 21, characterised in that the thermosetting resin impregnates the décor layer or overlay.

23. A process according to anyone of claims 15 to 22, characterised in that the hard particles applied to the décor layer or overlay comprise aluminium oxide, preferably with an average particle size of 1 to 100 μm, preferably 5 to 90 μm, more preferably 30 to 70 μm, and most preferably of 40 to 60 μm.

24. A process according to anyone of claims 15 to 22, characterised in that hard particles having two different average particle sizes, the bigger average diameter being in the range of between 30 to 90 μm, the smaller average diameter being in the range of between 0.001 to 15 μm, are applied to the décor layer or overlay.

25. A process according to claim 24, characterised in that only the hard particles having the bigger average particle size are applied to the décor layer or overlay by strewing them to or into the resin.

26. A process according to anyone of claims 15 to 25, characterised in that the amount of hard particles applied to the décor layer or overlay is in the range of 0.05 to 50 g/m², preferably of 1 to 40 g/m², most preferably of at least 16 and up to 35 g/m².

27. A process according to anyone of claims 15 to 26, characterised in that the hard particles are evenly distributed over the surface and depth of the thermosetting resin.

28. A process according to anyone of claims 15 to 27, characterised in that the feeding device comprises a rotating doctor-roll being in communication with the outlet of a feed hopper, preferably disposed parallel to the surface of the décor layer or overlay.

29. A process according to anyone of claims 15 to 28, characterised in that the electric field applied to the coated particles is produced by an electrode or electrode arrangement being in communication with the feeding device, the electrode or electrode arrangement having a positive or preferably a negative voltage potential with respect to the feeding device of at least 1 kV, preferably of 2 to 8 kV.

30. A process according to claim 29, characterised in that the distance between the feeding device and the electrode or electrode arrangement is in the range of between 5 to 20 mm.

31. A process according to any one of claims 28 to 30, characterised in that the feeding device and in particular the doctor-roll is grounded and has a electrically conducting surface.
